(19) United States
(12) Patent Application Publication
(10) Pub. No.: US 2021/0294121 A1
(43) Pub. Date: Sep. 23, 2021

(54) GOLF EYEGLASSES FOR ASSISTING DIRECTIONAL ALIGNMENT AND METHOD FOR OPERATING SAME

(71) Applicant: Cha Gyun JEONG, Yongin-si (KR)

(72) Inventor: Cha Gyun JEONG, Yongin-si (KR)

(21) Appl. No.: 16/330,361

(22) PCT Filed: Aug. 21, 2017
(86) PCT No.: PCT/KR2017/009101

§ 371 Date: Mar. 4, 2019

(30) Foreign Application Priority Data
Sep. 3, 2016 (KR) 10-2016-0113526
Aug. 21, 2017 (KR) 10-2017-0105474

(51) Int. Cl. G02C 5/00; G02C 11/04; A63B 69/36

(52) U.S. Cl. CPC G02C 5/003; G02C 11/04; A63B 2220/40; A63B 2225/50; A63B 69/3608

(57) ABSTRACT

Provided are golf eyeglasses for assisting directional alignment and a method for operating the same, wherein, inertial measurement devices, such as a gyro sensor and an accelerometer, installed in the golf eyeglasses are used to calculate the rotation angle of the golfer, and pairs of LEDs installed in both the front left-hand side and the front right-hand side of the eyeglasses blink at a period proportional to the rotation angle so that the golfer can know the direction and angle at which additional rotation/adjustment should be made, thereby assisting the golfer in achieving a set-up/address posture that is exactly at a right angle (90 degrees) with respect to the ball-to-target line.

### Technical Field

The present disclosure relates to golf eyeglasses, which assist in achieving a proper address position/posture wherein the direction in which the player is facing forms a right angle with respect to the ball-to-target line, and a method for operating the same, and more particularly, to golf eyeglasses for assisting directional alignment and a method for operating the same, wherein, inertial measurement devices, such as a gyro sensor and an accelerometer, installed in the golf eyeglasses are used to calculate the rotation angle of the golfer, and two pairs of LEDs installed in the front left-hand side and the front right-hand side of the eyeglasses blink at a period proportional to the rotation angle so that the golfer can know the direction and the angle at which additional rotation/adjustment should be made, thereby assisting the golfer in achieving set-up/address position/posture that is exactly at the right angle with respect to the ball-to-target line.

### BACKGROUND ART

Mechanical gyros have been mainly used for orientation control of an aircraft. Recently, with the development of electronic technologies and micro-machining technologies, micro-electro-mechanical system (MEMS) gyro sensors and accelerometers have been developed and embedded in various information devices such as smartphones, and applications having various functions using orientation information calculated by the MEMS gyro sensors and by the global positioning system (GPS) systems have been developed.

In sports, posture information is usefully applied, and particularly, in golf, portable GPS devices are widely used for acquiring distance information.

However, in golf, since both directional and distance information is important, products worn on the waist using an inertial measurement unit (IMU), such as synchronized gyro and accelerometer, have been developed. However, that the products should be worn on the waist creates limitations where information can only be transmitted through either acoustic or vibrational means, and where information is conveyed only when, and only consists in, the user (is) in a proper set-up/address posture/position. More specifically, the following problems exist.

First, a golfer looks in the direction of the ball-to-target line and presses a button to specify the direction to hit a golf ball. However, pressing the button creates shaking which in turn affects embedded gyro and acceleration sensors, creating errors in alignment/posture information.

Second, when the user begins to set up his/her address position by rotating from the ball-to-target direction, acoustic or vibrational media cannot efficiently deliver alignment information necessary to make adjustments. Only when the user arrives at a proper address position (within a substantial margin of error), the user is informed by sound or vibration. As such, vibrational media fall short in that it cannot transmit intermediate instructional information necessary to make adjustments to arrive at a proper address position, whereas acoustic media can transmit intermediate instructional information but its transmission speed is slow, such that problems are unresolved. Particularly, acoustic media faces great limitation because emanating sound becomes an undesired noise source to surrounding people including accompanying players.

In order to resolve such problems, it is ideal to have a form of glasses capable of transmitting information in a visual manner. At the present time, various attempts are being made to apply products such as Google Glass to sporting goods with an augmented reality technology that superimposes necessary information on glasses, but there are problems such as a limitation of use time, a large size, and social resistance of other players when the products are used for sports.

Furthermore, such augmented reality glasses are devices for directly projecting graphics on spectacle glasses using technology such as hologram, and in order for a user to recognize graphic information projected on the glasses, he/she must constantly shift the focus of his/her eyes, which creates dizziness when used for a prolonged period of time. Particularly, in golf, a user would have to wear the augmented reality glasses for many hours, usually for more than 5 hours for a standard round of golf which consists of 18 holes. Therefore it is a significant problem for a player to adjust the focus of his/her eyes during the subtle moment of hitting a golf ball.

Meantime, golf is a sport where it is necessary to consistently and accurately send a golf ball in the desired direction. As illustrated in FIG. 1, in order to hit a golf ball, a golfer must rotate clockwise (12) (or counterclockwise if the golfer is left-handed) to arrive at a proper address position, in which the player is exactly perpendicular with respect to the ball-to-target line (11) before hitting the golf ball.

In general, whereas one can easily and correctly orient himself or herself directionally when looking at a target directly ahead, when one is in a 90-degree rotated position with respect to the target and looks at the target from the side with a rotated face, it becomes significantly difficult to discern if one is properly aligned at a desired angle.

In professional golf, due to such problems, a companion game assistant (a caddy) corrects the golfer's alignment/address position by looking at the ball-to-target direction from behind the golfer. However, since an amateur golfer generally does not have the help of a game assistant (a caddy), it is very common to hit a golf ball in a wrong direction.

### CITATION LIST

### Non-Patent Literature

(Non-Patent Literature 0001) [Literature 1] Grant Baldwin, Robert Mahony, Jochen Trumpf, Tarek Hamel & Thibault Cheviron, “Complementary filter design on the Special Euclidean group SE(3),” Control Conference (ECC), 2007 European

### DISCLOSURE

### Technical Problem

Various embodiments are directed to provide golf eyeglasses for assisting directional alignment without social resistance, which are provided with an inertial measurement unit sensor (IMU sensor) and a light emitting diode (LED) easily obtainable in the ordinary market, which can calculate in real-time the rotation angle rotated from the ball-to-target direction by using a rotational angular speed acquired from an inertial measurement unit sensor (IMU sensor), and which can quickly and efficiently transmit the calculated rotation angle to a user in a visual manner, and a method for operating the same.

### Technical Solution

In an embodiment, golf eyeglasses for assisting directional alignment include a pair of LEDs (pair comprises of the first and the second LED) disposed on each side on the front of the golf eyeglasses; left and right boards disposed on respective side legs of the golf eyeglasses; and proximity sensors disposed on both the left and right boards, wherein the left and right boards are connected to each other by a flexible printed circuit board.

In an embodiment, a method for operating golf eyeglasses for assisting directional alignment includes: a step in which, when a user wearing the golf eyeglasses brings his/her hand close to a proximity sensor while looking in the direction of the ball-to-target line, the ball-to-target direction is recognized; a step in which, when the proximity sensor generates an interrupt INT to a main control unit, the main control unit switches from power saving mode to operation mode, sets the Z-axis rotation angle of an inertial measurement unit sensor to 0, and blinks both of the first LEDs at the same time, thereby notifying the user that a command is accurately recognized and performed; a step in which, when the user initially rotates about the Z-axis in order to set up his/her address posture/position, the rotation direction is recognized to determine whether the user is a left-handed or a right-handed user, and the blinking of the first LEDs are stopped; a step in which, in a case where the user continues to rotate to arrive at 90°, and where the rotation angle does not reach a predetermined range, one of the first LEDs blinks to display a direction in which further rotation is to be performed, as well as the additionally required amount of rotation; a step in which, when the rotation angle reaches the predetermined range, the first LED is turned off and both of the second LEDs are turned on to notify the user that he/she is in a proper address position/posture; a step of recognizing when the user tilts his/her spine at a predetermined angle in order to complete the set-up and turning off the blinking second LEDs, thereby notifying that the user is in a correct posture/set-up; and a step in which, when the user hits the ball and looks at the target, forming a parallel position with the ball-to-target line (0°), the power saving mode is automatically turned on.

### Advantageous Effects

According to the present invention, it is possible to manufacture golf glasses in conventional forms and shapes without social resistance. Specifically, errors applied to an inertial measurement unit sensor in extant products utilizing a button and vibrational or acoustic transmission media are removed by using a proximity sensor, and the Z-axis rotation angle acquired from an inertial measurement unit sensor is displayed on a LED that blinks at various periods, so that it is possible to quickly transmit information such that a golfer can recognize through his/her peripheral vision his/her alignment without shifting the focus of his/her eyes.

Consequently, a golfer wearing the golf eyeglasses for assisting directional alignment according to the present invention can achieve a correct address/set-up position/posture without the help of a game assistant, resulting in improvements in golf score.

### BRIEF DESCRIPTION OF DRAWINGS

FIG. 1 is a diagram for explaining the proper ball-to-target direction in a standard golf set-up/address.

FIG. 2 is a diagram illustrating a configuration of golf eyeglasses for assisting directional alignment according to the present invention.

FIG. 3 is a flowchart of a method for operating golf eyeglasses for assisting directional alignment according to the present invention.

FIG. 4 to FIG. 6 are diagrams for explaining each step of a method for operating golf eyeglasses for assisting directional alignment according to the present invention.

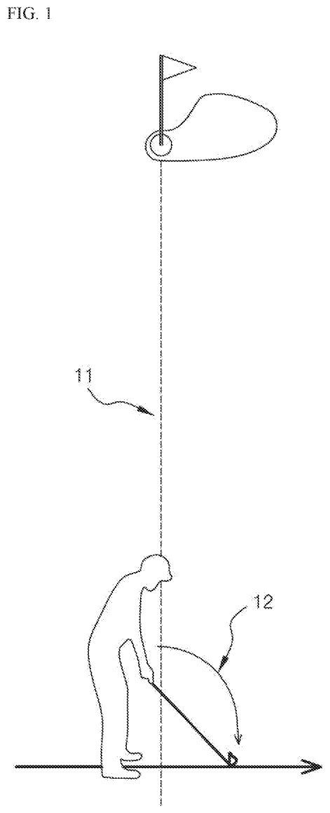

### MODE FOR DISCLOSURE

The present invention will be described in detail with reference to the accompanying drawings.

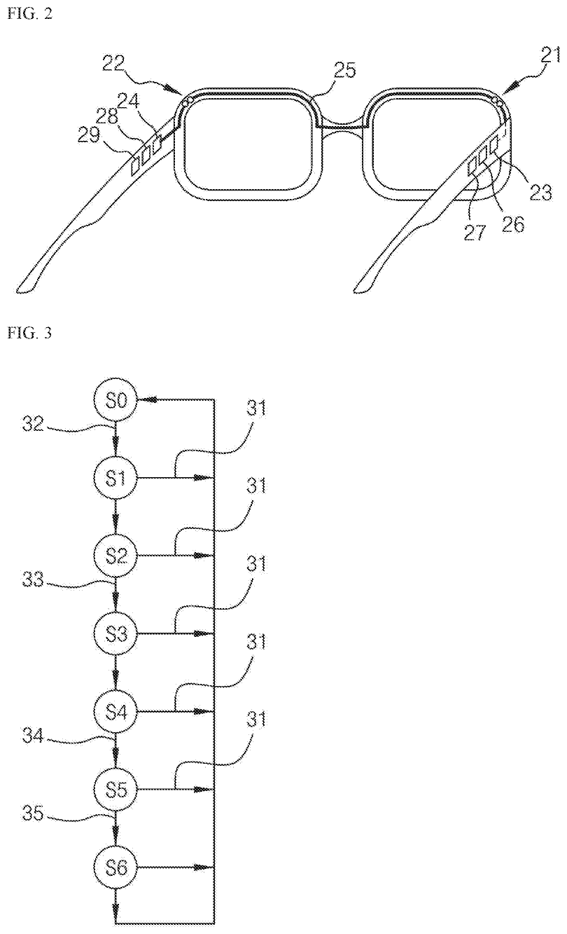

FIG. 2 is a diagram illustrating a configuration of golf eyeglasses for assisting directional alignment according to the present invention.

As illustrated in FIG. 2, the golf eyeglasses for assisting directional alignment according to the present invention include two pairs of the first and second LEDs 21 and 22 disposed on both sides on the front of the golf eyeglasses, left and right boards disposed on the respective side legs of the golf eyeglasses, and proximity sensors 23 and 24 respectively disposed on the left and right boards, and flexible printed circuit board 25 which connects the left and right boards.

Hereinafter, an example, in which the first LEDs are red LEDs and the second LEDs are blue LEDs, will be described; however, it is a matter of course that the color of the LEDs can be freely changed.

Furthermore, in this example, the right board is further provided with an inertial measurement unit sensor 26, and a main control unit and Bluetooth low energy communication unit (MCU/BLE) 27, and the left board is further provided with a charging device 28 and a rechargeable battery 29.

The reason for installing proximity sensors on both left and right sides as a pair is to allow the golfer to use whichever free hand that is not gripping the golf club to control the proximity sensor.

The golf eyeglasses for assisting directional alignment according to the present invention compute the rotation angle rotated from the ball-to-target direction by using the rotational angular speed acquired from an inertial measurement unit sensor 26, and blink the red LED 21 or the blue LED 22 according to the rotated angle, thereby allowing a user to easily recognize, via peripheral vision, information regarding the direction in which the user should further rotate and the amount of additional rotation to achieve a proper address position.

Golf glasses should be used in a visual manner in order to display information quickly and accurately, but it is necessary to devise methods that do not require the wearer to change the focus of his/her eyes. Further, the golf glasses should be very lightweight as to not burden a golf swing. Furthermore, motion control should be a contactless user interface that does not have an adverse influence on an inertial measurement unit (IMU).

To this end, the present invention provides a method in which a golfer can recognize the angle rotated from the ball-to-target direction to be aimed at =address/set-up without changing the focus of his/her eyes, and a method for visually displaying information by blinking light blue and red LEDs installed on the glasses in an appropriate manner.

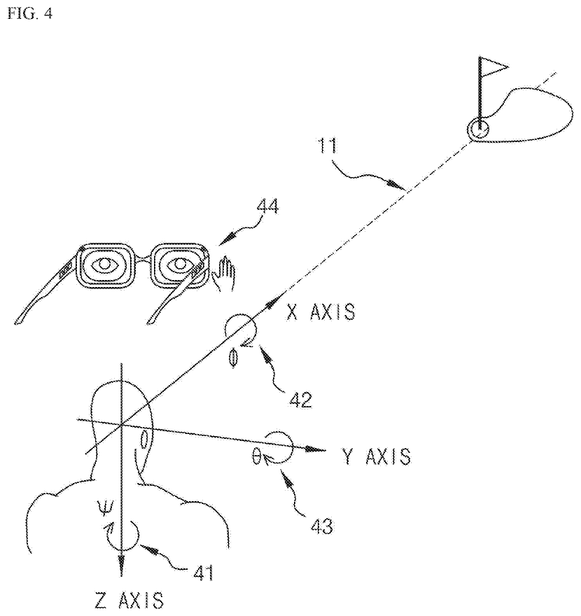

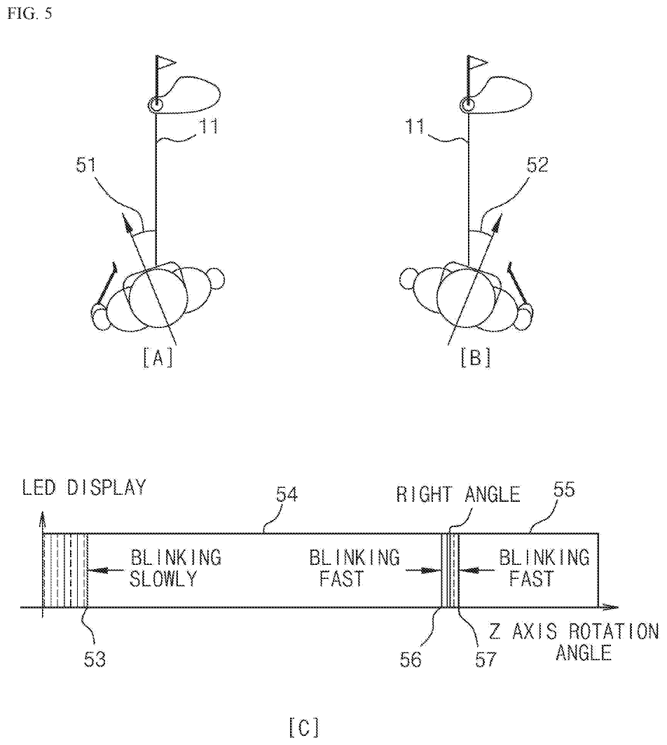

FIG. 3 is a flowchart of a method for operating the golf eyeglasses for assisting directional alignment according to the present invention, and FIG. 4 to FIG. 6 are diagrams for explaining each step of a method for operating the golf eyeglasses for assisting directional alignment according to the present invention.

With reference to FIG. 3 and FIG. 4 to FIG. 6, a method for operating the golf eyeglasses for assisting directional alignment according to the present invention will be described.

A method for operating the golf eyeglasses for assisting directional alignment according to the present invention includes the first step S1 to sixth step S6.

In the first step S1, a golfer brings his/her hand close to either proximity sensor located on both the left and right legs of the eyeglasses (32), switches the power saving mode in the initial state S0 to operation mode, and recognizes the ball-to-target direction to be aimed.

In the second step S2, after the first step S1, the Z-axis rotation angle of the inertial measurement unit sensor (IMU sensor) is initialized to 0° and both LEDs simultaneously blink to notify the golfer that the ball-to-target direction is recognized.

The third step S3, after the second step S2, is the step of recognizing the initial direction in which the golfer rotated, in order to recognize whether the golfer is a left-handed or a right-handed player when the golfer initially rotates clockwise or counter-clockwise about the Z-axis to set up(33).

In the fourth step S4, after the third step S3, when the golfer continues to rotate towards a right angle (90 degrees), the direction to further rotate and the necessary amount of additional rotation are displayed and conveyed by the period at which the red LED installed on the left or right side (depending on whether the golfer needs to rotate counter-clockwise or clockwise) of the eyeglasses blinks.

In the fifth step S5, after the fourth step S4, when the golfer enters a predetermined range (usually 1° within a right angle) (34), the red LED is turned off and the blue LEDs are turned on to notify the golfer that he/she has rotated the correct amount.

The method may further include, after the fifth step S5, a step 5-1 (S5-1), in which when the golfer tilts his/her spine at a predetermined angle in order to hit a golf ball, the blinking blue LEDs are turned off, thereby notifying that the golfer is in a proper set-up/address position/posture.

The sixth step S6 is a step of recognizing the point at which the Z-axis rotation angle again becomes 0° when the golfer hits the golf ball and returns to the target-to-ball direction (35), and entering the power saving mode in the initial state S0.

The information acquired in each step may be selectively transmitted to smart devices (smart-phones or smart watches) through Bluetooth low energy (BLE) communication for the purpose of additional analysis.

In the initial state, an inertial measurement unit sensor 26 and a main control unit MCU are in the power saving mode for saving power and the proximity sensors 23 and 24 are in a state capable of recognizing proximity. A process in which a user wearing the aforementioned product recognizes the direction in which to hit a golf ball will be described below.

As illustrated in FIG. 4, when the user visually confirms the ball-to-target direction (11) to be aimed at and then brings his/her hand close to a proximity sensor 23 or 24 disposed on the left and right side and hold his/her hand for a while (44), the proximity sensor recognizes the proximity and generates an interrupt INT to a main control unit MCU. The main control unit MCU, having received the interrupt INT, leaves the power saving mode, sets a gyro sensor serving as the inertial measurement unit sensor 26 to an operation mode, sets the rotation angle of the Z (41) axis to 0°, and uses values calculated by Equation 1 below from the accelerometer measurement value as initial angles of rotation of the X (42) axis and the Y (43) axis. In the present invention, as illustrated in FIG. 4, the ball-to-target direction is defined as the X-axis, the right-hand direction with respect to the ball-to-target direction is defined as the Y-axis, and the downward direction is defined as the Z-axis.

When the interrupt INT is generated in order to control the eyeglasses without using any button, the accelerometer value is used to determine whether the current position of the eyeglasses is facing forward, downward, or upward. When the eyeglasses are facing forward, a prescribed task in the operation mode is performed. When the eyeglasses are facing downward, a prescribed task in the system administration mode (software update) is performed. When the eyeglasses are not moved while facing upward, a prescribed task in the gyro calibration mode is performed.

$${∅}_{0} = {tan}^{-} ( \frac{{g}_{y}}{{g}_{z}} ) \\ {θ}_{0} = {tan}^{-} ( - \frac{{g}_{x}}{\sqrt{{g}_{y}^{2} + {g}_{x}^{2}}} ) \\ {ψ}_{0} = 0 \qquad Equation 1$$

In Equation 1 above, ψ denotes the Z-axis rotation angle, ϕ denotes the X-axis rotation angle, θ denotes the Y-axis rotation angle, and gx, gy, and gz denote accelerometer values.

$$R ( 0 ) = [ \begin{matrix}cos {θ}_{0} cos {ψ}_{0} & \begin{matrix}sin {∅}_{0} sin {θ}_{0} cos {ψ}_{0} - \\ cos {∅}_{0} sin {ψ}_{0}\end{matrix} & \begin{matrix}cos {∅}_{0} sin {θ}_{0} cos {ψ}_{0} + \\ sin {∅}_{0} sin {ψ}_{0}\end{matrix} \\ cos {θ}_{0} sin {ψ}_{0} & \begin{matrix}sin {∅}_{0} sin {θ}_{0} sin {ψ}_{0} + \\ cos {∅}_{0} cos {ψ}_{0}\end{matrix} & \begin{matrix}cos {∅}_{0} sin {θ}_{0} sin {ψ}_{0} - \\ sin {∅}_{0} cos {ψ}_{0}\end{matrix} \\ - sin {∅}_{0} & sin {∅}_{0} cos {θ}_{0} & cos {∅}_{0} cos {θ}_{0}\end{matrix} ]$$

R(0) denotes an initial rotation matrix that is used in Equation 2 below.

In order to notify the user that the eyeglasses recognize the user's command, the red LEDs installed on both sides simultaneously blink, thereby notifying that the hand motion is recognized and the main control unit MCU has been set to the operation mode. After this step, when a golfer rotates in order to set-up, the gyro sensor measures the instantaneous angular velocity and the rotation angle is obtained by Equation 2 below by using the instantaneous angular velocity of the gyro sensor. In Equation 2 below, Δt denotes a gyro sampling cycle.

$$R ( t + Δ t ) = R ( t ) [ \begin{matrix}1 & - {ω}_{z} Δ t & {ω}_{y} Δ t \\ {ω}_{2} Δ t & 1 & - {ω}_{x} Δ t \\ - {ω}_{y} Δ t & {ω}_{x} Δ t & 1\end{matrix} ] \\ R = [ \begin{matrix}{r}_{11} & {r}_{12} & {r}_{13} \\ {r}_{21} & {r}_{22} & {r}_{23} \\ {r}_{31} & {r}_{32} & {r}_{33}\end{matrix} ] \\ θ = - {sin}^{-} ( {r}_{31} ) \\ ∅ = tan {2}^{-} ( \frac{{r}_{21}}{cos θ} , \frac{{r}_{11}}{cos θ} ) \\ ψ = tan {2}^{-} ( \frac{{r}_{21}}{cos θ} , \frac{{r}_{11}}{cos θ} ) \qquad Equation 2$$

In Equation 2 above, ωₓ, ω_{y}, and ω_{z} denote the instantaneous angular velocity values of the gyro sensor.

Furthermore, R(t) denotes the rotational matrix indicating the amount of rotation at time t, and rᵢⱼ denotes elements of a 3×3 matrix.

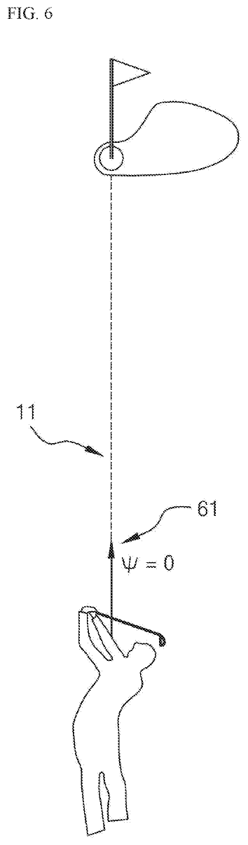

Then, as illustrated in FIG. 5, the right-handed user starts rotation (52) clockwise and the left-handed user starts rotation (51) counter-clockwise. In such a case, both red LEDs are turned off (53) to notify that the eyeglasses have recognized the user's motion and whether the user is right-handed left-handed is recognized using the initial rotation direction.

In the case of a right-handed user, when the amount of rotation is 90° or less (54), the right red LED blinks, and when the amount of rotation exceeds 90° (55), the left red LED blinks, thereby notifying additional necessary rotation or adjustment in a certain direction. In the same principle, in the case of a left-handed user, when the amount of rotation is 90° or less (54), the left red LED blinks, and when the amount of rotation exceeds 90° (55), the right red LED blinks, thereby notifying additional rotation or adjustment in a certain direction.

In both of the aforementioned cases, as illustrated in FIG. 5(C), the LED's blinking period is generated proportional to the angle to be additionally rotated so that the user can know how much additional rotation is required. Particularly, when it comes to a certain error range of about 1° within a right angle (between 56 and 57), the red LED stops blinking and the blue LED turns on so that it can be easily recognized that the user is close to the right angle.

When the user corrects or calibrates the direction on the basis of the position and the blinking period of the continuously blinking LED, a position of 90° alignment easily occurs. In such a case, both blue LEDs blink at the same time, thereby notifying the user of the 90° alignment. Then, when the user tilts his/her upper body in order to complete the address/set-up position, the angle of rotation in the Y-axis is calculated using Equation 2 above. When the angle reaches a prescribed range (for example, 45°), the blinking left and right blue LEDs stop blinking to notify that the user is finally in a proper address position. Exceptionally, when the user cancels the direction alignment during the aforementioned alignment process, the user brings his/her hand close to either proximity sensor 23 or 24 disposed on both sides so that the initial state S0 of FIG. 3 can be restored.

Once in a proper address position wherein the user forms a right angle (90°) with the ball-to-target direction, the user performs a golf swing, and at the end of the swing, naturally looks at the direction in which the golf ball is flying. In this process, as illustrated in FIG. 6, the main control unit MCU recognizes the time point (61) at which the Z-axis rotation angle of the inertial measurement unit (IMU) becomes 0, sets the inertial measurement unit sensor (IMU sensor) to the power saving mode, and switches its mode to the power saving mode in which only the proximity sensors 23 and 24 can be recognized. Consequently, the initial state of FIG. 3 is automatically restored without additional user control so that the process of FIG. 3 can be repeatedly used.

While various embodiments have been described above, it will be understood to those skilled in the art that the embodiments described are by way of example only. Accordingly, the disclosure described herein should not be limited based on the described embodiments.

1. Golf eyeglasses for assisting directional alignment, comprising of:
A pair of LEDs (a pair consists of the first LED and second LED) disposed on each side on the front of the golf eyeglasses;
left board and right board disposed on the left leg and the right leg of the golf eyeglasses, respectively; and
proximity sensors disposed on the left board and the right board,
wherein the left board and the right board are connected to each other by a flexible printed circuit board.

2. The golf eyeglasses for assisting directional alignment according to claim 1, wherein one of the left board and the right board is further provided with an inertial measurement unit sensor, a main control unit and a Bluetooth low energy communication unit, and
the remaining one of the left board and the right board is further provided with a charging device and a rechargeable battery.

3. The golf eyeglasses for assisting directional alignment according to claim 2, wherein the rotation angle rotated from the ball-to-target direction is computed using the rotational angular speed acquired from the inertial measurement unit sensor, and
the first LED or the second LED is blinked according to the rotated angle, thereby allowing a user to easily recognize the direction in which he/she needs to further rotate, as well as the amount of additional rotation.

4. The golf eyeglasses for assisting directional alignment according to claim 3, wherein the rotation angle of the user is calculated by Equation 1 and Equation 2 below,
$${∅}_{0} = {tan}^{-} ( \frac{{g}_{y}}{{g}_{z}} ) \\ {θ}_{0} = {tan}^{-} ( - \frac{{g}_{x}}{\sqrt{{g}_{y}^{2} + {g}_{x}^{2}}} ) \\ {ψ}_{0} = 0 \qquad Equation 1$$
in Equation 1 above, ψ denotes the Z-axis rotation angle, ϕ denotes the X-axis rotation angle, θ denotes the Y-axis rotation angle, and gx, gy, and gz denote accelerometer values, and
$$R ( t + Δ t ) = R ( t ) [ \begin{matrix}1 & - {ω}_{z} Δ t & {ω}_{y} Δ t \\ {ω}_{2} Δ t & 1 & - {ω}_{x} Δ t \\ - {ω}_{y} Δ t & {ω}_{x} Δ t & 1\end{matrix} ] \\ R = [ \begin{matrix}{r}_{11} & {r}_{12} & {r}_{13} \\ {r}_{21} & {r}_{22} & {r}_{23} \\ {r}_{31} & {r}_{32} & {r}_{33}\end{matrix} ] \\ θ = - {sin}^{-} ( {r}_{31} ) \\ ∅ = tan {2}^{-} ( \frac{{r}_{21}}{cos θ} , \frac{{r}_{11}}{cos θ} ) \\ ψ = tan {2}^{-} ( \frac{{r}_{21}}{cos θ} , \frac{{r}_{11}}{cos θ} ) \qquad Equation 2$$
In Equation 2 above, ωₓ, ω_{y}, and ω_{z} denote instantaneous angular velocity values of a gyro sensor.

5. The golf eyeglasses for assisting directional alignment according to claim 4, wherein, when a user wearing the golf eyeglasses brings his/her hand close to a proximity sensor while looking in the ball-to-target direction, the ball-to-target direction is recognized,
when the proximity sensor generates an interrupt INT to a main control unit, the main control unit switches to operation mode from power saving mode, sets the Z-axis rotation angle of an inertial measurement unit sensor to 0, and blinks both of the first LEDs at the same time, thereby notifying the user that a command is accurately recognized,
when the user initially rotates about the Z-axis to set up, the rotation direction is recognized to determine whether the user is a left-handed or a right-handed user, and the blinking of the first LEDs are stopped,
in a case where the user continues to rotate to set up, and where the rotation angle does not reach a predetermined range, one of the first LEDs blinks to display the direction in which further rotation/adjustment is to be made, as well as the additionally required amount of rotation,
when the rotation angle reaches a predetermined range, the first LED is turned off and both of the second LEDs are turned on to notify the user that a proper address position/set-up has been achieved,
when a user tilts his/her spine at a predetermined angle to arrive at a proper address posture, tilting is recognized and both of the second LEDs are turned off to notify a user that he/she is in a proper address position/posture, and
when the user hits the ball and looks in the ball-to-target direction in a finish posture, the power saving mode is automatically turned on.

6. A method for operating golf eyeglasses for assisting directional alignment, comprising:
A step S1 in which, when a user wearing the golf eyeglasses brings his/her hand close to a proximity sensor while looking in the ball-to-target direction, the ball-to-target direction is recognized;
a step S2 in which, when a proximity sensor generates an interrupt INT to a main control unit, the main control unit switches to operation mode from power saving mode, sets the Z-axis rotation angle of an inertial measurement unit sensor to 0, and blinks both of the first LEDs at the same time, thereby notifying the user that a command is accurately recognized;
a step S3 in which, when the user initially rotates about the Z-axis to set up the address posture, the rotation direction is recognized to determine whether the user is a left-handed or a right-handed user, and the blinking of both of the first LEDs is stopped;
a step S4 in which, in a case where the user continues to rotate, and where the rotation angle does not reach a predetermined range, one of the first LEDs blinks to display the direction in which further rotation/adjustment is to be made, as well as the additionally required amount of rotation;
a step S5 in which, when the rotation angle reaches a predetermined range, the blinking first LED is turned off and both of the second LEDs are turned on to notify the user that a proper address position/posture is achieved; and
a step S6 in which, when a user hits the ball and looks in the ball-to-target direction in finish posture, the power saving mode is automatically turned on.

7. The method for operating the golf eyeglasses for assisting directional alignment according to claim 6, after step S5, comprising of:
a step S5-1 of recognizing when the user tilts his/her spine at a predetermined angle in order to complete the set-up and turning off the blinking second LEDs, thereby notifying the user that he/she is in a proper address position/posture.

8. The method for operating the golf eyeglasses for assisting directional alignment according to claim 6, wherein the rotation angle of the user is calculated by Equation 1 and Equation 2 below,
$${∅}_{0} = {tan}^{-} ( \frac{{g}_{y}}{{g}_{z}} ) \\ {θ}_{0} = {tan}^{-} ( - \frac{{g}_{x}}{\sqrt{{g}_{y}^{2} + {g}_{x}^{2}}} ) \\ {ψ}_{0} = 0 \qquad Equation 1$$
In Equation 1 above, ψ denotes the Z-axis rotation angle, ϕ denotes the X-axis rotation angle, θ denotes the Y-axis rotation angle, and gx, gy, and gz denote accelerometer values, and
$$R ( t + Δ t ) = R ( t ) [ \begin{matrix}1 & - {ω}_{z} Δ t & {ω}_{y} Δ t \\ {ω}_{2} Δ t & 1 & - {ω}_{x} Δ t \\ - {ω}_{y} Δ t & {ω}_{x} Δ t & 1\end{matrix} ] \\ R = [ \begin{matrix}{r}_{11} & {r}_{12} & {r}_{13} \\ {r}_{21} & {r}_{22} & {r}_{23} \\ {r}_{31} & {r}_{32} & {r}_{33}\end{matrix} ] \\ θ = - {sin}^{-} ( {r}_{31} ) \\ ∅ = tan {2}^{-} ( \frac{{r}_{21}}{cos θ} , \frac{{r}_{11}}{cos θ} ) \\ ψ = tan {2}^{-} ( \frac{{r}_{21}}{cos θ} , \frac{{r}_{11}}{cos θ} ) \qquad Equation 2$$
In Equation 2 above, ωₓ, ω_{y}, and ω_{z} denote instantaneous angular velocity values of a gyro sensor.

9. The method for operating the golf eyeglasses for assisting directional alignment according to claim 8, further comprising of:
A step of transmitting acquired information of a user to smart devices through Bluetooth low energy communication unit(BLE).

10. The method for operating the golf eyeglasses for assisting directional alignment according to claim 6,wherein, to perform additional functions without using any push buttons , an accelerometer reading is used to determine whether the current position of the eyeglasses is facing forward, downward, or upward when the proximity interrupt (INT) is generated, and then prescribed tasks are performed in normal operation mode when the eyeglasses are facing forward, in a system administration mode (software update) when the eyeglasses are facing downward, or in a gyro calibration mode when the eyeglasses are not moving while facing upward.
